(19) United States
(12) Patent Application Publication
(10) Pub. No.: US 2015/0363696 A1
(43) Pub. Date: Dec. 17, 2015

(54) METHOD AND SYSTEM FOR GENERATING A COLLECTIVE GROUP RESPONSE

(71) Applicant: reMesh

(72) Inventors: Andrew Konya, Kent, OH (US); Aaron Slodov, Cleveland Heights, OH (US)

(21) Appl. No.: 14/304,033

(22) Filed: Jun. 13, 2014

(51) Int. Cl. G06N 5/02

(52) U.S. Cl. CPC G06N 5/022

(57) ABSTRACT

A method and system for generating a collective group response, in which a plurality of users are provided with an initial input, and at least one response is received from the users. The at least one user of the plurality of users is provided a plurality of answer options, wherein the plurality of answer options is at least partially responsive to the response matrix. The size of the response matrix is decreased until a predetermined diversity value is reached. Further, a collective group response, which is at least partially responsive to the response matrix, is transmitted.

### CROSS-REFERENCE TO RELATED APPLICATIONS

This application claims priority to U.S. Provisional Application Ser. No. t/b/d, filed on t/b/d entitled “METHOD FOR ENABLING TWO-WAY COMMUNICATION FROM A MULTI-POINT SOURCE TO AN INDIVIDUAL,” the entirety of which is incorporated herein by reference.

### TECHNICAL FIELD

The present invention relates to a method and system for generating a collective group response and, more particularly, to method and system for generating a collective group response which best fits the preferences of the group's members.

### BACKGROUND

Modern life standards can hardly be imagined without communication systems for individuals and groups, e.g., Internet and TV. Those communication systems have been evolving from old standards and currently include an array of interactive tools allowing people to communicate in different ways. With current technology, one person can broadcast a message to a practically unlimited number of persons.

However, known communication techniques inhibit such unlimited number of persons from generating a collective group response to a broadcast. Social networks, email, sms, video, and any other current communication tools, are capable of one-to-one and one-to-many communications, but fail to provide a group of people with a means for expressing their will as a collective.

### SUMMARY

In an embodiment of the present invention, a method for generating a collective response is described. The method comprises providing a plurality of users with an initial input, and receiving at least one response from at least one of the plurality of users. A response matrix comprising the at least one response is generated. The at least one user of the plurality of users is provided a plurality of answer options, wherein the plurality of answer options is at least partially responsive to the response matrix. The size of the response matrix is decreased until a predetermined diversity value is reached. Further, a collective group response, which is at least partially responsive to the response matrix, is transmitted.

In an embodiment of the present invention, a computer readable storage medium having data stored therein representing software executable by a computer, including instructions for selecting a single response which represents a group of responses, is described. The storage medium comprises instructions for providing an initial input to a plurality of users and receiving at least one response, wherein the at least one response comprises a response from at least one user of the plurality of users. The storage medium also comprises instructions for generating at least one computer response at least partially responsive to the at least one response. Also, there are instructions for generating a response matrix comprising the at least one response and the at least one computer response. Further, the medium comprises instructions for providing, to at least one user of the plurality of users, a plurality of answer options, wherein the plurality of answer options is at least partially responsive to the response matrix. In addition, there are instructions for receiving at least one user answer which is at least partially responsive to the plurality of answer options, and for ranking the at least one response and the at least one computer response at least partially responsive to the at least one user answer. Moreover, there are instructions for reducing the size of the response matrix at least partially responsive to the ranking of the at least one response and the at least one computer response. Finally, the storage medium has instructions for transmitting a collective group response, wherein the collective group responsive is at least partially responsive to the response matrix.

In another embodiment of the present invention, a system for generating a collective group response is described. The system comprises a processor that executes or facilitates execution of computer executable components stored in a non-transitory memory. The computer executable components comprise an initial input component for providing a plurality of users with an initial input. Further, there is a response component for receiving at least one response from at least one of the plurality of users, and a matrix component for generating a response matrix comprising the at least one response. Also, the system comprises an options component for providing at least one of the plurality of users a plurality of answer options, wherein the plurality of answer options is at least partially responsive to the response matrix. Additionally, there is a reduction component for decreasing the size of the response matrix until a predetermined diversity value is reached. Moreover, system comprises a collective group response component for transmitting the collective group response, wherein the collective group response is at least partially responsive to the response matrix.

In an embodiment of the present invention, a method for selecting a collective group response is described. The method comprises providing a plurality of users with an initial input, and receiving at least one response from at least one of the plurality of users. Also, at least one computer response is generated which is at least partially responsive to the at least one response. Further, the method comprises selecting the collective group response responsive to the at least one response and the at least one computer response.

### BRIEF DESCRIPTION OF THE DRAWINGS

FIG. 1 is a flow chart of an embodiment of the present invention.

FIG. 2 is a flow chart which further expands upon the embodiment of FIG. 1.

FIG. 3 is a system for using the flow charts of FIG. 1 and FIG. 2.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without specific details. In other instances, well-known structures and devices are shown in block diagram form in order to facilitate describing these aspects.

As used in this application, the terms “component,” “system,” and the like are intended to refer to a computer-related entity, including hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects will be presented in terms of systems that may include a number of components, modules, and the like. It is to be understood and appreciated that the various systems may include additional components, modules, etc. and/or may not include all the components, modules, etc. discussed in connection with the Figures. A combination of these approaches may also be used. The various aspects disclosed herein can be performed on electrical devices including devices that utilize touch screen display technologies and/or mouse-and-keyboard type interfaces. Examples of such electronic devices include computers (desktop and mobile), smart phones, personal digital assistants (PDAs), and other electronic devices, both wired and wireless.

“Processor,” as used herein includes, but is not limited to, one or more of virtually any number of processor systems or stand-alone processors, such as microprocessors, microcontrollers, central processing units (CPUs), distributed processors, paired processors, and digital signal processors (DSPs), in any combination. The processor may be associated with various other circuits that support operation of the processor, such as random access memory (RAM), read-only memory (ROM), programmable read-only memory (PROM), erasable programmable read-only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings

The present invention relates to generating a collective group response regarding an initial input. “Collective group response,” as used herein, refers to a response which best fits the expressed preferences of a group, wherein the group comprises a plurality of users. The collective group response is determined to best fit the preferences of the plurality of users through the methods and system described herein.

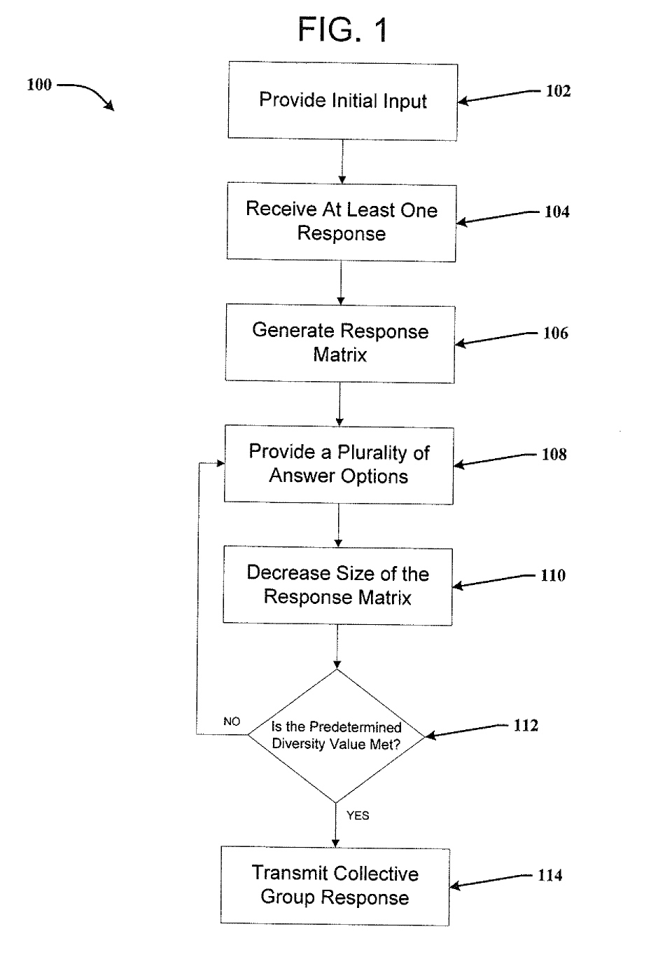

FIG. 1 is a flow chart illustrating a method for generating a collective group response which represents the preferences of a plurality of users. The plurality of users collectively comprise a group. Membership parameters of the group define which particular users, and the number of users, that may comprise the group. The group's membership parameters can be based on: a user interest, a user location, a user identity, a predetermined number of users, a user demographic (e.g. age, sex, income, and the like), a predetermined admission time, a combination thereof, and the like. For example, a group may be limited to the first thousand users who request admission to the group and live in the United States. Furthermore, the membership parameters can restrict the users based on a password requirement, membership identification, a combination thereof, and the like. Alternatively, the group's membership parameters can allow the group to be open to all users who request admission.

In the first block 102, an initial input is provided to each user of the plurality of users which comprise the group. The initial input can be provided to each of the users visually, audibly, and by a combination thereof. The initial input can be at least one of: a statement, a word, a question, a command, a combination thereof, and the like. The initial input can be automatically generated by a computer or created by a third party. The third party can be an individual, an organization, a corporation, another group, and the like. For example, the president of the United States may create the initial input, “Do you think we should increase taxes to improve public education?”

In the second block 104, at least one response is received from at least one of the plurality of users. Each user is permitted to submit a response in regards to the initial input. The at least one response can be at least one of: a statement, a word, a question, a command, a combination thereof; and the like. The user can be limited to submitting a single response, or can be permitted to submit multiple responses. The responses received from the plurality of users in the group are utilized in the third block 106 to generate a response matrix. The response matrix initially comprises of all the responses received from the plurality of users in the group. Additionally, the response matrix can further comprise computer generated responses. The at least one response, and if applicable, the computer generated responses, are initially stored in an unranked format, or all the responses are initially ranked equivalently.

In the fourth block 108, the plurality of users is provided a plurality of answer options. The answer options can be provided to each user in the group, or only to those users which have submitted a response. The plurality of answer options comprises multiple responses selected randomly from the response matrix. The number of answer options which comprise the plurality of answer options can vary based on a predetermined value or a customizable setting. For example, the plurality of answer options may comprise three responses selected randomly from the response matrix. Further, the plurality of answer options for one user are selected independently from a plurality of answer options selected for another user. The user is prompted to choose an answer which indicates a preferred answer from the plurality of answer options. Additionally, the plurality of answer options can include an answer which indicates that none of the answer options are a preferred answer.

In the fifth block 110, the size of the response matrix is decreased at least partially based on the answers chosen by the plurality of users. Reponses, and if applicable, computer generated responses, chosen least often by the plurality of users are removed from the response matrix. As the response matrix decreases in size, its diversity is reduced. The diversity amongst the remaining responses, and if applicable, computer generated responses, in the response matrix is measured as a diversity value. The diversity value can be the function of: a similarity analysis, a comparative analysis, a numerical analysis, a combination thereof, and the like. For example, the more responses present in the response matrix, the higher the diversity value. In another example, a multitude of similar responses may result in the response matrix having a low diversity value despite having comprise numerous responses.

In the sixth block 112, it is determined whether the measured diversity in the response matrix has met a predetermined diversity value. If the predetermined diversity value has been met, then the remaining at least one response, if applicable, at least one computer generated response, or combination thereof in the response matrix best represents the preferences of the group and is transmitted, at the seventh block 114, to the creator of the initial input as the collective group response. If the predetermined value has not been met, then the method 100 returns to the fourth block 108 and each of the users in the group is provided a plurality of answer options randomly selected from the response matrix, wherein the response matrix is now reduced in size from when a plurality of answer options were previously provided. Thus, by returning to the fourth block 108 and proceeding with the method 100, the size of the response matrix is continuously reduced until the predetermined diversity value is met.

In addition to the collective group response, data regarding the plurality of users, the at least one response, the at least one user answer, the at least one computer generated response, the ranking of the at least one response and the at least one computer generated response, a combination thereof, and the like can be transmitted to the initial input creator. For example, the creator of the initial input may be transmitted all the responses received by the plurality users and how frequently each response was selected as an answer. Such data can be stored for a desired amount of time to enable the initial input creator to review the collective group response and corresponding data to of all his/her initial inputs created over a duration of time.

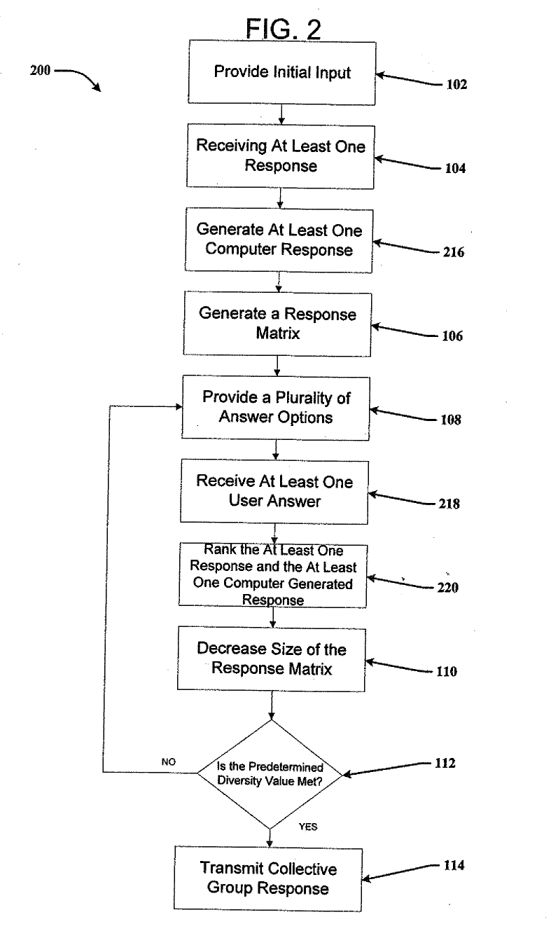

FIG. 2 is a flow chart illustrating one embodiment in which the method 100 of FIG. 1 is performed. The method 200 of FIG. 2 begins as described above with respect to the method 100 of FIG. 1, wherein an initial input is provided to a group at the first block 102 and at least one response is received from users comprising the group at the second block 104. After the at least one response is received in the second block 104, at least one computer response is generated at the computer response block 216. Each computer response is generated based at least partially on a separate response received from a user. A language model is built using the at least one response received from the users, and the at least one response is altered within the stochastic bounds of the language model to produce the at least one computer generated response. The computer generated response can be based on a single response, or on multiple responses. For example, responses of “We really want to build a new bridge” and “a new bridge across the Hudson River would be nice” can provide the basis for a computer generated response of “We really want to build a new bridge across the Hudson River.”

In the third block 106, the response matrix comprises both the at least one response received from the users and the at least one computer generated response. The at least one response and the at least one computer generated response are initially stored in the response matrix in an unranked order.

In the fourth block 108, each user comprising the group is provided a plurality of answer options. Each answer option is at least one of: a response selected randomly from the response matrix, or a computer generated response selected randomly from the response matrix. Additionally, the plurality of answer options comprises a default option. The default option can permit the user to: indicate that none of the answer options are preferred, leave the group, and the like. An example of a default option may be “I do not prefer any of the options listed below.” Each user will then be prompted to select the answer option which he/she most prefers.

The user answers are received from the users at receiving block 218. At ranking block 220, the responses received from the users and the computer generated responses are ranked within the response matrix based on the received user answers. One of ordinary skill in the art will recognize numerous sorting techniques which can be utilized to perform the ranking, including: an ideal point model, a Bayesian analysis, the Bradley-Terry model, a combination thereof, and the like. For example, a numerical method can be utilized in which the response or computer generated response corresponding to the received user answer is assigned a positive value. The at least one response or the at least one computer generated response corresponding to the other answer options in the plurality of answer options which were not selected by the users are assigned a negative value. If the user answer correlates to the default option, then the at least one response or at least one computer generated response are assigned a negative value. The at least one response and the at least one computer generated response are then ranked in the response matrix according to their assigned value.

In the fifth block 110, the size of the response matrix is decreased based at least partially on the ranking of the at least one response and the at least one computer generated response. For example, a predetermined number of responses and computer generated responses can be removed from the response matrix based on their assigned rank. The predetermined number of responses and computer generated responses to be removed can be a number value, a percentage of the total size of the response matrix, a combination thereof, and the like. In another example, stochastic reduction is utilized such that responses and computer generated responses are not fully eliminated, but rather the frequency which they are sampled is decreased.

In the sixth block 112, the reduced response matrix is measured to determine whether its diversity meets a predetermined diversity value. As discussed above with respect to FIG. 1, if the diversity value is not met, the method 200 repeats itself starting from the fourth block 108, wherein the users are provided a plurality of answer options, at least one user answer is received, the at least one response and the at least one computer generated response are ranked in the response matrix, and the response matrix is reduced in size. The method 200 repeats this loop back to the fourth block 108, reducing the size of the response matrix and thereby the response matrix's diversity, until the predetermined diversity value is met. Once the predetermined diversity value has been determined to be met, the remaining at least one response, computer generated response, or combination thereof is transmitted to the creator of the initial input as the collective group response.

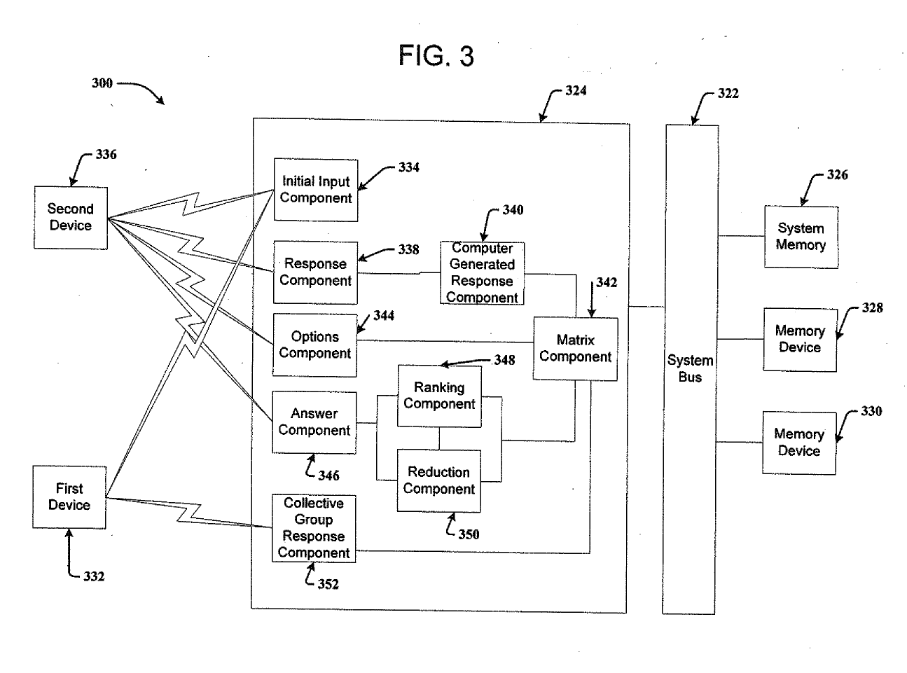

FIG. 3 is a schematic block diagram illustrating an exemplary system 300 of components capable of implementing examples of the methods disclosed in FIGS. 1 and 2. The system 300 can include various systems and subsystems. The system 300 can be a personal computer, a laptop computer, a workstation, a computer system, an appliance, an application-specific integrated circuit (ASIC), a server, a server blade center, a server farm, etc.

The system 300 can includes a system bus 322, a processor 324, a system memory 326, and memory devices 328 and 330. The system bus 322 can be in communication with the processor 324 and the system memory 326. The additional memory devices 328 and 330, such as a hard disk drive, server, stand alone database, or other non-volatile memory, can also be in communication with the system bus 322. The system bus 322 interconnects the processor 324, the memory devices 328 and 330, and the system memory 326. In some examples, the system bus 322 also interconnects an additional port (not shown), such as a universal serial bus (USB) port.

The processor 324 can be a computing device and can include an application-specific integrated circuit (AMC). The processor 324 comprises multiple components to execute a set of instructions to implement the operations of examples disclosed herein. The processor 324 can include a processing core.

The additional memory devices 326, 328 and 330 can store data, programs, instructions, database queries in text or compiled form, and any other information that can be needed to operate a computer. The memories 326, 328 and 330 can be implemented as computer-readable media (integrated or removable) such as a memory card, disk drive, compact disk (CD), or server accessible over a network. In certain examples, the memories 326, 328 and 330 can comprise text, images, video, and/or audio, portions of which can be available in formats comprehensible to human beings.

Computer executable logic for implementing portions of methods 100 and 200 reside on one or more of the system memory 326, and the memory devices 328, 330 in accordance with certain examples. The processor 324 executes one or more computer executable instructions originating from the system memory 326 and the memory devices 328 and 330. The term “computer readable medium” as used herein refers to a medium or media that participates in providing instructions to the processer 324 for execution. It will thus be appreciated a computer readable medium is non-transitory and can include multiple discrete media that are operatively connected to the processing unit, for example, via one or more of a local bus or an network connection.

In operation, the system 300 can be used to implement one or more parts of FIG. 1 and FIG. 2 in accordance with the present invention. A first device 332 is in communication with the system 300. The first device 332 is controlled by the initial input creator and used to transmit the initial input to the initial input component 334. The initial input component 334 provides the initial input to a plurality of second devices 336, each of which is operated by a user comprising the plurality of users. Each user utilizes their respective second device 336 to transmit the at least one response to the response component 338, which receives the at least one response from the plurality of users. A computer generated response component 340 can create the at least one computer generated response at least partially responsive to the at least one response received by the response component 338. A matrix component 342 generates the response matrix comprising the at least one response and the at least one computer generated response. An options component 344 provides the users with the plurality of answer options selected from the response matrix. An answer component 346 receives the at least one user answer from the plurality of users, wherein the at least one user answer indicates a user's preferred answer. A ranking component 348 ranks the at least one response and the at least one computer generated response based on the user answers received by the answer component 346. A reduction component 350 decreases the size of the response matrix at least partially based on the ranking, the received answers, or a combination thereof. The matrix component 342 measures the diversity value of the response matrix. If a predetermined diversity value has not been met, then the options component 344 provides the plurality of users with new plurality of answer options, selected from the reduced response matrix. When a predetermined diversity value is reached, a collective group response component 352 transmits the collective group response to the initial input creator (e.g. the first device 332). Further, the collective group response component 352 can transmit data regarding the plurality of users, the at least one response, the at least one user answer, the at least one computer generated response, the ranking of the at least one response and the at least one computer generated response, a combination thereof, and the like can be transmitted to the initial input creator.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification is intended to embrace all such alterations, modifications, and variations.

In particular and in regard to the various functions performed by the above described components, devices, methods, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description, these terms are intended to be inclusive in a manner similar to the term “comprising.”

The term “or” as used in either the detailed description or the clams is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular feint.

We claim:

1. A method for generating a collective group response, the method comprising:
providing a plurality of users with an initial input;
receiving at least one response from at least one of the plurality of users;
generating a response matrix comprising the at least one response;
providing at least one user of the plurality of users a plurality of answer options, wherein the plurality of answer options is at least partially responsive to the response matrix;
decreasing the size of the response matrix until a predetermined diversity value is reached; and
transmitting the collective group response, wherein the collective group response is at least partially responsive to the response matrix.

2. The method of clam 1, wherein the response matrix further comprises at least one computer generated response at least partially responsive to the at least one response.

3. The method of claim 1, further comprising receiving at least one user answer responsive to the plurality of answer options.

4. The method of claim 3, wherein the at least one user answer indicates a preferred answer from the plurality of answer options.

5. The method of claim 3, wherein the size of the response matrix is decreased at least partially responsive to the at least one user answer.

6. The method of claim 3, further comprising storing at least one of the at least one response and the at least one user answer.

7. A computer readable storage medium having data stored therein representing software executable by a computer, the software including instructions for selecting a single response which represents a group of responses, the storage medium comprising:
instructions for providing an initial input to a plurality of users;
instructions for receiving at least one response, wherein the at least one response comprises a response from at least one user of the plurality of users;
instructions for generating at least one computer response at least partially responsive to the at least one response;
instructions for generating a response matrix comprising the at least one response and the at least one computer response;
instructions for providing, to at least one user of the plurality of users, a plurality of answer options, wherein the plurality of answer options is at least partially responsive to the response matrix;
instructions for receiving at least one user answer, wherein the user answer is at least partially responsive to the plurality of answer options;
instructions for ranking the at least one response and the at least one computer response at least partially responsive to the at least one user answer;
instructions for reducing the size of the response matrix at least partially responsive to the ranking of the at least one response and the at least one computer response; and
instructions for transmitting a collective group response, wherein the collective group response is at least partially responsive to the response matrix.

8. The computer readable storage medium of claim 7, wherein the initial input can be at least one of: a statement, a word, a question, a command, and a combination thereof.

9. The computer readable storage medium of claim 7, wherein the size of the response matrix is reduced until a predetermined diversity value is reached.

10. The computer readable storage medium of claim 7, wherein the at least one user answer indicates a preferred answer option from the plurality of answer options.

11. The computer readable storage medium of claim 7, wherein the collective group response is at least partially responsive to the response matrix after the size of the response matrix has been reduced.

12. The computer readable storage medium of claim 7, further comprising instructions for storing at least one of: the at least one response, the at least one user answer, and the ranking of the at least one response and the at least one computer response.

13. A system for generating a collective group response, the system comprising:
a processor that executes or facilitates execution of computer executable components stored in a non-transitory memory, the computer executable components comprising:
an initial input component for providing a plurality of users with an initial input;
a response component for receiving at least one response from at least one of the plurality of users;
a matrix component for generating a response matrix comprising the at least one response;
an options component for providing at least one user of the plurality of users a plurality of answer options, wherein the plurality of answer options is at least partially responsive to the response matrix;
a reduction component for decreasing the size of the response matrix until a predetermined diversity value is reached; and
a collective group response component for transmitting the collective group response, wherein the collective group response is at least partially responsive to the response matrix.

14. The system of clam 13, wherein the response matrix further comprises at least one computer generated response at least partially responsive to the at least one response.

15. The system of claim 13, further comprising an answer component for receiving at least one user answer responsive to the plurality of answer options.

16. The system of claim 15, wherein the size of the response matrix is decreased at least partially responsive to the at least one user answer.

17. The system of claim 15, further comprising a ranking component for ranking the at least one response at least partially responsive to the at least one user answer; and wherein the decrease in the size of the response matrix is at least partially responsive to the ranking.

18. The system of claim 17, wherein the collective group response component further transmits at least one of: the at least one response, the at least one user answer, and the ranking of the at least one response.
